(19) United States
(12) Patent Application Publication
(10) Pub. No.: US 2020/0192135 A1
(43) Pub. Date: Jun. 18, 2020

(54) ARRAY SUBSTRATE, MANUFACTURING METHOD FOR THE ARRAY SUBSTRATE, AND DISPLAY PANEL

(71) Applicant: Wuhan China Star Optoelectronics Technology Co., Ltd., Wuhan (CN)

(72) Inventors: Xiaohui NIE, Wuhan (CN); Jiawei ZHANG, Wuhan (CN)

(73) Assignee: Wuhan china Star Optoelectronics Technology Co., Ltd., Wuhan (CN)

(21) Appl. No.: 16/325,412

(22) PCT Filed: Jan. 3, 2019
(86) PCT No.: PCT/CN2019/070195

§ 371 Date: Feb. 14, 2019

(30) Foreign Application Priority Data
Jul. 26, 2018 (CN) 201810837545.6

(51) Int. Cl. G02F 1/1337; G02F 1/1339

(52) U.S. Cl. CPC G02F 1/1337; G02F 2001/133776; G02F 1/13394

(57) ABSTRACT

An array substrate, a display panel, and a manufacturing method for the array substrate are provided, and can effectively decrease issues of damage to an alignment film layer due to photo spacers (especially the main photo spacers) exerted with an external force and scraps generated by the alignment film layer to prevent defective display issues, such as light spots, and further to increase anti-fall reliability of the display panel.

### FIELD OF INVENTION

The present invention relates to a field of display technologies, especially to an array substrate, a display panel, and a manufacturing method for the array substrate.

### BACKGROUND OF INVENTION

With reference to FIG. 1, a conventional thin film transistor liquid crystal display (TFT-LCD, i.e., a thin film field effect transistor liquid crystal display) is composed of a TFT substrate (including a thin film transistor device layer 110, a planarization layer 120, an alignment film layer 130, a color filter (CF) substrate 140, and an in-between liquid crystal. A common electrode layer 121, a passivation layer 122, and a pixel electrode layer 123 are disposed between the planarization layer 120 and the alignment film layer 130. A working principle of the TFT-LCD panel is that under the applied voltage control, because of the dielectric anisotropy of the liquid crystal, liquid crystal molecules rotate such that a refractive index or light transmittance of the liquid crystal is changed accordingly to control the amount of light emitted by the TFT-LCD.

To better control amount of light emitted from the liquid crystal in the TFT-LCD panel, generally in a cell process, both the TFT substrate (or called array substrate) and the color filter (CF) substrate are coated with a layer of polyimide (PI) alignment film 130. By employing a stronger force in the interface between the liquid crystal and the PI alignment film, when externally exerting voltage is removed, the liquid crystal molecules after changing their arranging direction regain their original state by viscoelasticity. Therefore, the PI alignment film is required to have characteristics of uniformity, adhesion, and stability.

A cell gap of the TFT-LCD panel is generally defined by a quantity of the liquid crystal filled into the cell. Under the effect of external pressure or gravity, the TFT-LCD panel is prone to have an uneven cell gap, which affects light transmittance, a contrast ratio, and a corresponding speed of the TFT-LCD panel. Therefore, a general industry technical solution is by exposure and etching processes of forming photo spacers (PSs) 150 on a CF substrate with the photo spacers disposed between the TFT substrate and the CF substrate to buffer external pressure exerting on the TFT-LCD panel such that uniformity of the cell gap is maintained. Depending on the heights of the photo spacers and the primary and secondary functions for buffering pressure, the photo spacers can be divided into main photo spacers (MPSs) and sub-photo spacers (Sub PSs).

### SUMMARY OF INVENTION

### Technical Issue

However, in the practical application of the TFT-LCD panel, the external force (such as F shown in FIG. 1) of the TFT-LCD panel is often deformed by force. The sliding of the main photo spacers (the sliding direction A shown in FIG. 1) is likely to cause damage to the PI alignment film, which causes disorder of alignment of the liquid crystal and the occurrence of broken spots and other undesirable phenomena.

### Technical Solution

An objective of the present invention is to provide an array substrate, a display panel and a manufacturing method for the array substrate that effectively reduce scraps generated due to photo spacers (especially main photo spacers) exerted with an external force and damaging an alignment film layer, prevent defective display issues such as light spots, and further increase anti-fall reliability of the display panel.

To achieve the above objective, the present invention provides an array substrate, comprising a base substrate, wherein the array substrate further comprises: a thin film transistor device layer, the thin film transistor device layer disposed on the base substrate; a planarization layer, the planarization layer disposed on the thin film transistor device layer; an alignment film layer, the alignment film layer located above the planarization layer; a plurality of photo spacer regions defined in the alignment film layer, and positioned corresponding to photo spacers for supporting the array substrate and a color filter substrate, wherein the photo spacer regions are recess-shaped, and the photo spacer regions are configured to limit sliding ranges of the photo spacers; a plurality of first regions defined in the planarization layer and corresponding to the photo spacer regions, and the first regions are recess-shaped.

In an embodiment of the present invention, a depth of each of the photo spacer regions of the alignment film layer is equal to a thickness of non-photo spacer regions other than the photo spacer regions of the alignment film layer.

In an embodiment of the present invention, a depth of a recess of each of the first regions of the planarization layer is one fifth of a thickness of the planarization layer.

In an embodiment of the present invention, the thin film transistor device layer comprises a buffer layer, an active layer, a gate insulation layer, a gate electrode, an inter-dielectric layer and a source and drain layer that are sequentially stacked upon one another.

In an embodiment of the present invention, a common electrode layer, a passivation layer and a pixel electrode layer that are sequentially stacked upon one another are disposed between the planarization layer and the alignment film layer.

Furthermore, the present invention also provides a display panel, the display panel comprises the above array substrate, a color filter substrate disposed opposite to the array substrate, and a plurality of photo spacers disposed between the array substrate and the color filter substrate, wherein the photo spacers are configured to support the array substrate and the color filter substrate.

In an embodiment of the present invention, the photo spacers are main photo spacers, and a transverse cross-section of each of the main photo spacers perpendicular to the array substrate is invertedly trapezoid-shaped.

In an embodiment of the present invention, a first width of an end of each of the photo spacers near the array substrate is less than a second width of the photo spacer regions, and W2=W1+N, wherein W2 is the second width, W1 is the first width, N is a gap range between the second width and the first width, a value of the gap range of N is 10 μm-15 μm.

Furthermore, the present invention also provides a manufacturing method for the above array substrate, the manufacturing method comprises steps as follows: (a) providing a base substrate; (b) forming a thin film transistor device layer on the base substrate; (c) forming a planarization layer on the thin film transistor device layer; (d) by an exposure and develop process with a halftone mask plate, forming first regions that are recess-shaped on the planarization layer, wherein the first regions correspond to photo spacers configured to support the array substrate and a color filter substrate; and (e) dropping an alignment liquid on an alignment plate, and transferring the alignment liquid from the alignment plate to the array substrate to form an alignment film layer on a planarization layer comprising the first regions, wherein the alignment film layer comprises photo spacer regions that are recess-shaped and correspond to the photo spacers

In an embodiment of the present invention, a number of drops of the alignment liquid is controlled by setting parameters of a machine, and an interval between adjacent drops of the alignment liquid is determined by the alignment plate.

In an embodiment of the present invention, steps between the step (d) and the step (e) are as follows: sequentially forming a common electrode layer, a passivation layer and a pixel electrode layer on the planarization layer comprising the first regions; and

by an exposure and develop process, forming patterns on the pixel electrode layer to remove parts of the pixel electrode layer corresponding to the photo spacers.

### Advantages

Advantages of the present invention lie in that the array substrate, the display panel, the liquid crystal display and the manufacturing method for the array substrate of the present invention can effectively reduce scraps generated due to photo spacers (especially main photo spacers) exerted with an external force and damaging an alignment film layer, prevent defective display issues such as light spots, further increase anti-fall reliability of the display panel and further increases quality of the products.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a schematic structural view of a conventional display panel;

FIG. 2 is a schematic structural view of an array substrate of an embodiment of the present invention;

FIG. 3 is a schematic structural view of a display panel of an embodiment of the present invention;

FIG. 4 is a schematic structural view of a liquid crystal display of an embodiment of the present invention;

FIG. 5 is a flowchart of a manufacturing method for an array substrate of an embodiment of the present invention; and

FIGS. 6A to 6H are schematic views of processes for manufacturing the array substrate of the embodiment of the present invention.

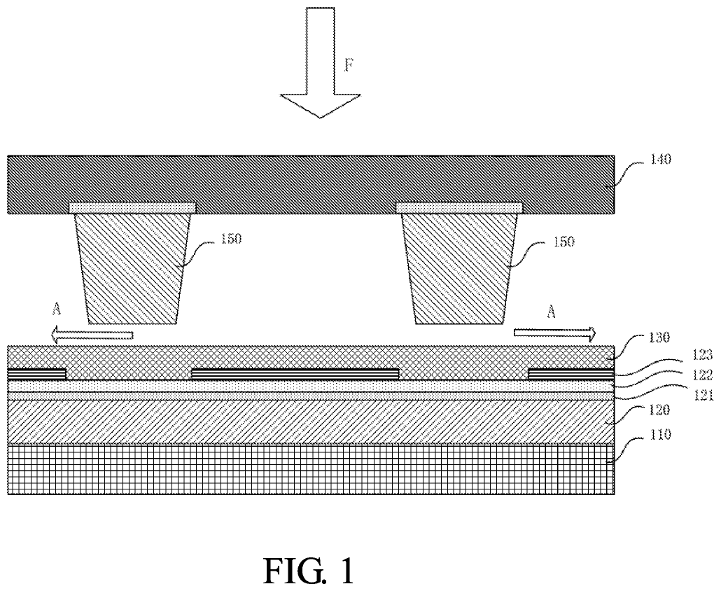

### DETAILED DESCRIPTION OF PREFERRED EMBODIMENTS

The technical solution in the embodiment of the present invention will be clearly and completely described below with reference to the accompanying drawings in the embodiments of the present invention. Apparently, the described embodiments are merely some embodiments of the present invention instead of all embodiments. According to the embodiments in the present invention, all other embodiments obtained by those skilled in the art without making any creative effort shall fall within the protection scope of the present invention.

The specification and claims of the present invention and terminologies “first”, “second”, “third”, etc. (if existing) in the above accompanying drawings are configured to distinguish similar objects and are not configured to describe a specific sequence or order thereof. It should be understood that such described objects can be exchanged with one another in an adequate condition. Furthermore, terminologies “include”, “have” and any variant thereof are intended to inclusive inclusion instead of exclusive inclusion.

In the present patent document, the drawings, which are discussed below, are used to describe the principles of the present invention, are for illustrative purposes only and are not to be construed as limiting the scope of the present invention. It will be understood by a person skilled in the art that the principles of the present invention may be implemented in any suitably arranged system. Exemplary embodiments will be described in detail, and examples of the embodiments are illustrated in the accompanying drawings. Further, a device according to an exemplary embodiment will be described in detail with reference to the accompanying drawings. The same reference numerals in the drawings refer to the same elements.

The terminologies used in the specification of the present invention are only used to describe the specific embodiments, and are not intended to show the concept of the present invention. Unless the context clearly has a different meaning, the expression used in the singular form encompasses the plural form of expression. In the present invention, it should be understood that terminologies such as “comprise”, “have” and “include” are intended to indicate the possibility of the features, numbers, steps, actions or combinations thereof disclosed in the present invention. It is not intended to exclude the possibility that one or a plurality of other features, numbers, steps, actions or combinations thereof may be added. The same reference numerals in the drawings refer to the same parts.

The present invention embodiment provides an array substrate, a display panel, a liquid crystal display, and a manufacturing method for the array substrate, which will be described respectively later.

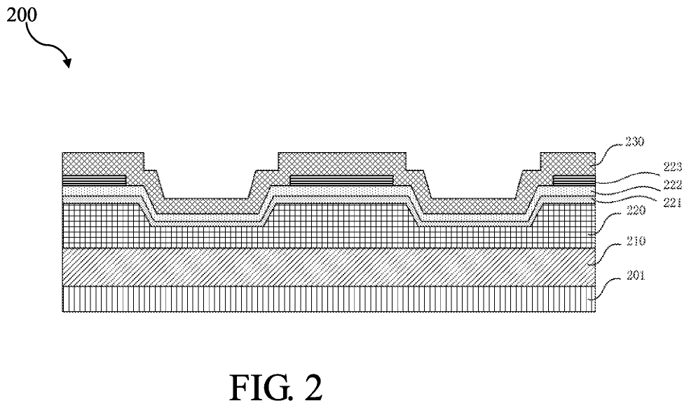

With reference to FIG. 2, the present invention provides an array substrate 200 comprising a base substrate 201. The array substrate 200 also comprises a thin film transistor device layer 210, a planarization (PN) layer 220, and an alignment film layer 230. The thin film transistor device layer 210 is disposed on the base substrate 201. The planarization layer 220 is disposed on the thin film transistor device layer 210. The alignment film layer 230 is located above the planarization layer 220 (it should be noted that the alignment film layer 230 does not contact the thin film transistor device layer 210 directly). A common electrode layer, a passivation layer, and a pixel electrode layer are disposed between the thin film transistor device layer 210 and the alignment film layer 230, which will be described as follows. The planarization layer 220 is a film layer formed by an organic material and has sufficient rigidity to provide required pressure. Furthermore, the base substrate 201 can be a glass substrate, or can be a transparent substrate made of other material.

Furthermore, the thin film transistor device layer 210 can include a buffer layer, an active layer, a gate insulation layer, a gate electrode, an inter-dielectric layer, and a source and drain layer (these layers are not shown in the figures) that are sequentially stacked upon one another from bottom to top. These disposed functional layers are known to a person of ordinary skill in the art and will not be described repeatedly herein. It should be noted that in order to show more clearly the technical solution of the present invention, specific structures of the thin film transistor device layer 210 are omitted in the accompanying drawings, and a schematic view is made to illustrate position relations between the thin film transistor device layer 210 and other functional layers.

In the manufacturing process of a thin film transistor liquid crystal display (TFT-LCD) panel, a basic structure of either of the array substrate 200 and a color filter substrate, is a lamination layer structure similar to a sandwich. By an exposing and etching process, specific patterns are formed in different film layers to achieve specific functions. Because the structure of an array substrate film layer, a non-metallic film layer has a metal film layer including not only line-shaped patterns but also hole-shaped patterns, therefore, the manufactured thin film transistor device layer 210 has an uneven surface, which is disadvantages for later manufacture of the alignment film layer. A general method in the art is that after the manufacture of a thin film transistor layer, the planarization layer 220 with a greater thickness is coated onto the thin film transistor layer for surface planarization, and then the common electrode layer 221, a passivation layer 222, a pixel electrode layer 223 and the alignment film layer 230 are manufactured on the PN layer.

In the present embodiment, the common electrode layer 221, the passivation layer 222, and the pixel electrode layer 223 sequentially manufactured on the planarization layer 220. Positions of each of the common electrode layer 221, the passivation layer 222, and the pixel electrode layer 223 corresponding to photo spacers 320 are correspondingly recess-shaped. The common electrode layer 221, the passivation layer 222, and the pixel electrode layer 223 can be formed by a method such as a deposition method known in the art. The alignment film layer 230 is further disposed on the pixel electrode layer 223.

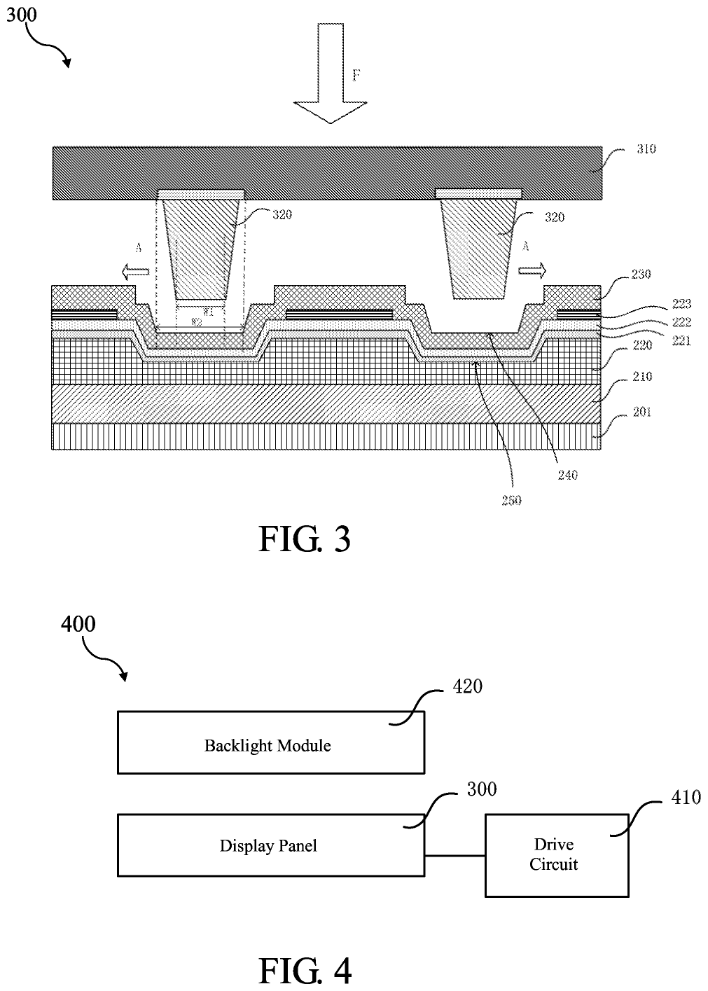

In the present embodiment, a plurality of photo spacer regions 240 are formed on the alignment film layer 230 and correspond to the photo spacers 320 configured to support the array substrate 200 and a color filter substrate 310 (as shown in FIG. 3), as shown in FIG. 3. The photo spacer regions 240 are recess-shaped. The photo spacer regions 240 can limit sliding ranges of the photo spacers 320 in the photo spacer regions respectively. More specifically, the photo spacer regions 240 can limit sliding ranges of the photo spacers 320 along a direction A in FIG. 3. When the TFT-LCD panel is exerted with an impact of an external force due to falling (force F as shown in FIG. 3), because the photo spacer regions 240 can limit the sliding ranges, the sliding ranges of the photo spacers 320 (for examples, main photo spacers, MPSs) are limited, damage of the alignment film layer is restricted in the photo spacer regions (i.e., the ranges of the recesses). Therefore, the damage to the alignment film layer due to the photo spacers 320 (especially the main photo spacers) exerted with the force and scraps generated by the alignment film layer are effectively decreased to prevent defective display issues, such as light spots, and further to increase anti-fall reliability of the display panel.

Preferably, a thickness of the photo spacer regions 240 of the alignment film layer is the same as a thickness of non-photo spacer regions (not shown in the figures) of the alignment film layer except for the photo spacer regions. In the present embodiment, the alignment film layer is a polyimide (PI) alignment film layer, by a nozzle, an alignment liquid (the alignment liquid can be but is not limited to a PI alignment liquid) is dropped on to an alignment plate, and then the alignment plate is transferred to the array substrate 200 to form PI drops at same intervals and with same volume. Finally, a PI alignment film layer is formed. A number of the drops (the alignment liquid) dropped by the nozzle can be adjusted by machine setting parameters. The intervals of the drops of the alignment liquid is determined by the design of the alignment plate (for example, sizes of apertures of the alignment plate). The alignment liquids, after transferred to the array substrate 200, naturally spread such that adjacent PI alignment liquids are connected into one piece to form a thin film with an even thickness. Such a method of naturally spreading and forming a film can assure that the thickness of the photo spacer regions of the alignment film layer is the same as the thickness of the non-photo spacer regions of the alignment film layer except for the photo spacer regions.

Furthermore, the thickness of the photo spacer regions 240 and the thickness of the non-photo spacer regions of the alignment film layer are designed adequately to further decrease the scraps of the alignment film generated due to friction between the photo spacers 320 and the alignment film layer 230 and improve quality of the products.

In the present embodiment, the planarization layer 220 is formed with a plurality of first regions corresponding to the photo spacer regions 240, and the first regions correspondingly recess-shaped. In other words, the first regions correspond to the photo spacers 320. Because the planarization layer 220 is an organic planarization layer and is made of a photosensitive material, by employing a halftone mask plate and an exposure and development process, manufacturing shallow recesses in the planarization layer 220 corresponding to the positions (i.e., the first regions) of the photo spacer regions 240 can be achieved. Specifically, the planarization layer 220 is coated, and then by the halftone mask plate, the positions (i.e., the positions corresponding to the photo spacers 320) in which the shallow recesses to be defined are exposed. A photochemical reaction changes characteristics of the organic material (i.e., exposure), and then by a photographic developer to strip parts of the film layer on the exposed positions of the planarization layer 220, parts of the film layer on the non-exposed positions are preserved. Therefore, the first regions are formed on the positions of the planarization layer 220 corresponding to the photo spacers 320, and second regions (not shown in the figures) are formed on the positions of the planarization layer 220 other than the first regions. In the present embodiment, a depth of the recesses of the first regions of the planarization layer 220 corresponding to the photo spacers 320 is one fifth of a thickness of the planarization layer.

With reference to FIG. 3, an embodiment of the present invention provides a display panel 300. The display panel 300 comprises the above array substrate 200, a color filter substrate 310 disposed opposite to the array substrate 200, and a plurality of photo spacers 320 disposed between the array substrate 200 and the color filter substrate 310. The photo spacers 320 are configured to support the array substrate 200 and the color filter substrate 310. It should be noted that the photo spacers below refer to main photo spacers.

The array substrate 200 includes a transparent base substrate 201, a thin film transistor device layer 210, a planarization layer 220, and an alignment film layer 230. The thin film transistor device layer 210 is disposed on the base substrate 201. The planarization layer 220 is disposed on the thin film transistor device layer 210. The alignment film layer 230 is located on the planarization layer 220. The thin film transistor device layer 210 includes a buffer layer, an active layer, a gate insulation layer, a gate electrode, an inter-dielectric layer, and a source and drain layer that are sequentially stacked upon one another from bottom to top. It should be noted that, in order to show more clearly the technical solution of the present invention, specific structures of the thin film transistor device layer 210 are omitted in the accompanying drawings, and a schematic view is made to illustrate position relations between the thin film transistor device layer 210 and other functional layers.

Between the planarization layer 220 and the alignment film layer 230 are a common electrode layer 221, a passivation layer 222, and a pixel electrode layer 223 that are sequentially disposed upon one another from bottom to top.

The planarization layer 220 is formed with a plurality of first regions 250 corresponding to the photo spacer regions 240, and the first regions 250 are correspondingly recess-shaped. Because the planarization layer 220 is an organic planarization layer and is made of a photosensitive material, by employing a halftone mask and an exposure and development process, manufacturing shallow recesses in the planarization layer 220 corresponding to the positions (i.e., the first regions 250) of the photo spacer regions 240 can be achieved.

In the present embodiment, the photo spacers 320 are main photo spacers, and a cross-section of each of the main photo spacers along a direction perpendicular to the array substrate 200 is invertedly trapezoid-shaped, a length of a topline of the inverted trapezoid far away from the array substrate 200 is greater than a baseline of the inverted trapezoid near the array substrate 200, and an included angle of the baseline and a lateral side of the trapezoid is an obtuse angle. Of course, the shape of the main photo spacers is not limited to an inverted trapezoid. In another embodiment, a cross-section of each of the main photo spacers is rectangular.

In the present embodiment, the plurality of photo spacer regions 240 are formed on the alignment film layer 230 and correspond to the photo spacers 320 configured to support the array substrate 200 and the color filter substrate 310 (as shown in FIG. 3). The photo spacer regions 240 are recess-shaped. The photo spacer regions 240 can limit sliding ranges of the photo spacers 320 in the photo spacer regions respectively. When the TFT-LCD panel is exerted with an impact of an external force due to falling (force F as shown in FIG. 3), because the photo spacer regions 240 can limit the sliding ranges, the sliding ranges of the photo spacers 320 (for examples, main photo spacers, MPSs) are limited, damage of the alignment film layer is restricted in the photo spacer regions (i.e., the ranges of the recesses). Therefore, the damage to the alignment film layer due to the photo spacers 320 (especially the main photo spacers) exerted with the force and scraps generated by the alignment film layer are effectively decreased to prevent defective display issues, such as light spots, and to further increase anti-fall reliability of the display panel, and further to improve quality of the products.

Furthermore, in the present embodiment, a first width of an end of the photo spacers 320 near the array substrate 200 is less than a second width of the photo spacer regions 240, and W2=W1+N, wherein as shown in FIG. 3, W2 is the second width, W1 is the first width, N is a gap range between the second width and the first width, a value of the gap range of N is 10 μm-15 μm. Therefore, by settings of the first width, the second width, and the gap range, the sliding ranges of the photo spacers 320 in the photo spacer regions 240 can be effectively controlled further, which more effectively prevents issues of damages to the alignment film layer 230 due to the photo spacers 320 (especially the main photo spacers) exerted with an external force and generated scraps of the alignment film layer, and efficiently controls displaying errors, such as light spots.

Furthermore, the thickness of the photo spacer regions 240 and the thickness of non-photo spacer regions of the alignment film layer are designed adequately to further decrease the scraps of the alignment film generated due to friction between the photo spacers 320 and the alignment film layer 230 and improve quality of the products. In the present embodiment, the thickness of the photo spacer regions of the alignment film layer 230 is the same as the thickness of the non-photo spacer regions.

In the present embodiment, projections of the photo spacers 320 on the array substrate 200 are within wiring regions of the array substrate 200, and the wiring regions are configured to dispose data lines or scan lines. Specifically, the photo spacers stand on metal lines between two pixel electrodes. It should be noted that, the wiring regions can provide signal wiring regions for the array substrate 200.

Furthermore, in the present embodiment, the design of the photo spacer regions 240 is mainly for controlling the main photo spacers (MPSs) to move within a moving range of the photo spacer regions (i.e., recesses) of the alignment film layer 230 due to the external force. Of course, in other embodiments, the above manner is also configured to control sub-photo spacers (SPSs) to move within a moving range of photo spacer regions (i.e., recesses) of the alignment film layer 230.

With reference FIG. 4, the present invention also provides a liquid crystal display 400. The liquid crystal display 400 includes the above display panel 300, a drive circuit 410, and a backlight module 420. The drive circuit 410 is configured to drive the above display panel 300. The backlight module 420 is configured to provide a backlight source for the display panel 300. The display panel is the display panel 300 of the above embodiment. In other embodiments, the display panel can be the display panel including functions and features of the above display panel 300. Specifically, the liquid crystal display 400 can be a device, such as a TV, a computer, and an outdoor advertising tablet that requires a display panel. In the present invention, the liquid crystal display 400 includes the display panel 300. An array substrate 200 in the display panel 300 includes a base substrate 201, a thin film transistor device layer 210, a planarization layer 220, and an alignment film layer 230. The thin film transistor device layer 210 is disposed on the base substrate 201. The planarization layer 220 is disposed on the thin film transistor device layer 210. The alignment film layer 230 is located on the planarization layer 220. A plurality of photo spacer regions 240 are formed on the alignment film layer 230, and correspond to the photo spacers configured to support the array substrate and a color filter substrate. The photo spacer regions 240 recess-shaped. The photo spacer regions 240 can limit sliding ranges of photo spacers 320 in the photo spacer regions respectively. The planarization layer 220 is formed with a plurality of first regions 250 corresponding to the photo spacer regions 240. The first regions 250 are correspondingly recess-shaped. The liquid crystal display 400 with such a design can effectively prevent issues of damage to the alignment film layer 230 due to the photo spacers 320 (especially the main photo spacers) exerted with the force and scraps generated by the alignment film layer, and can prevent defective display issues, such as light spots, to further increase anti-fall reliability of the display panel.

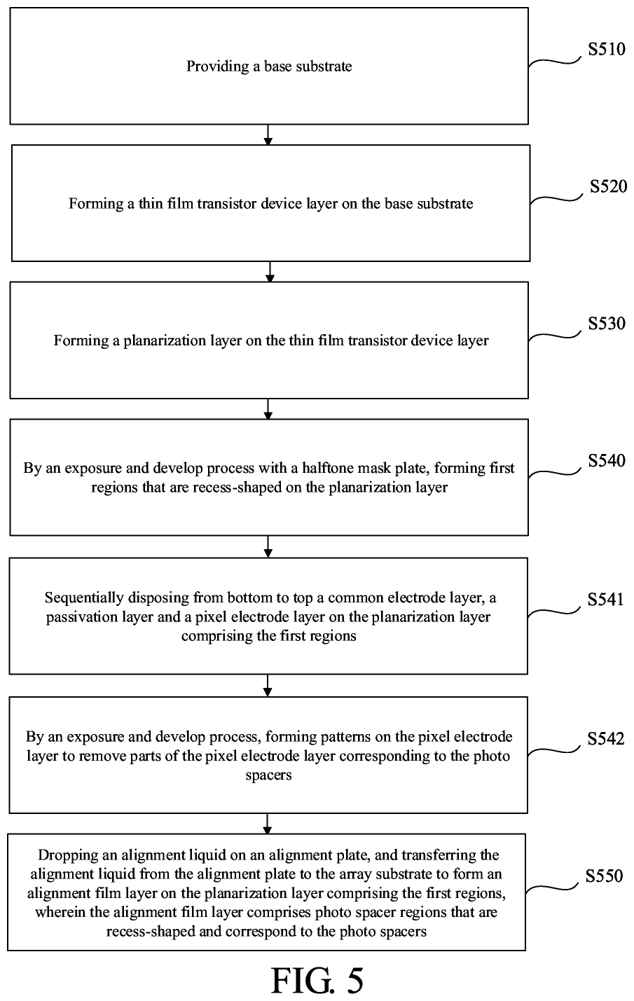

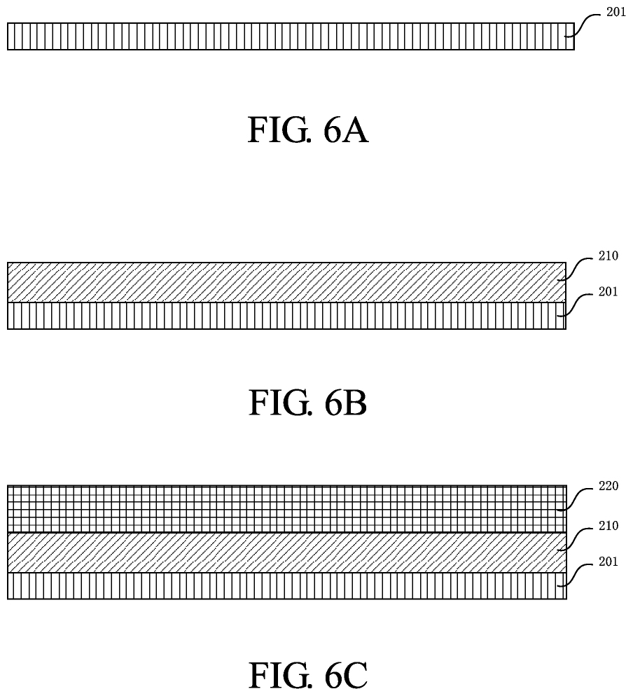

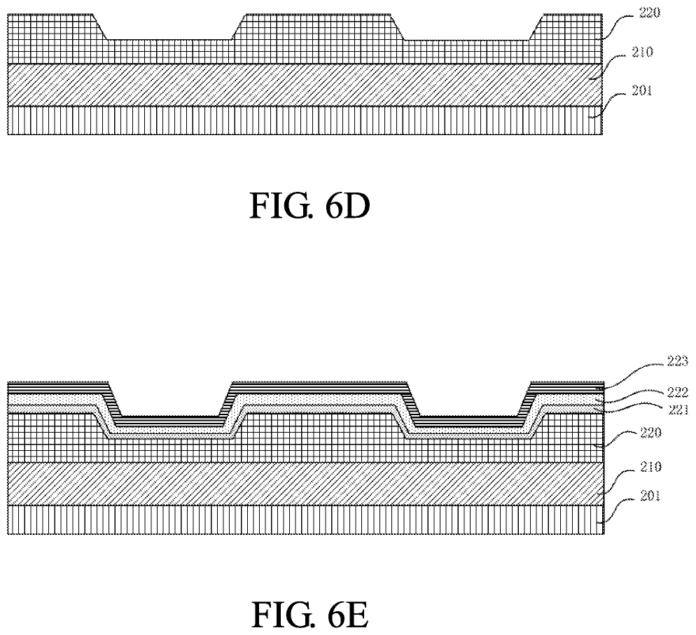

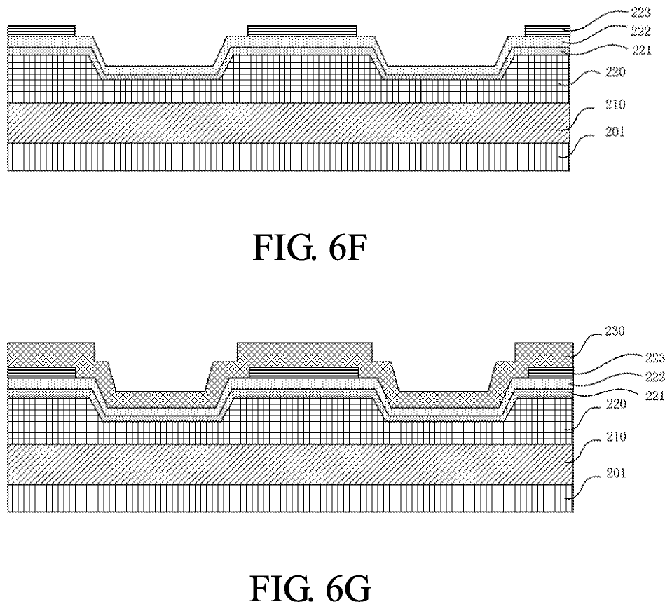

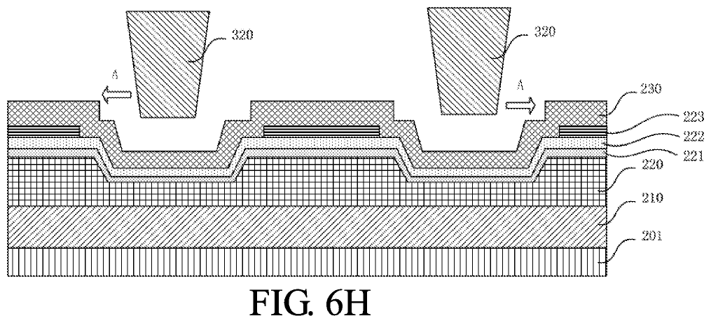

With reference to FIG. 5 and FIGS. 6A to 6H, a manufacturing method for an array substrate will be described in details. The manufacturing method includes steps as follows.

With reference to step S510 and FIG. 6A, the step S510 includes providing a base substrate.

The base substrate is a glass substrate, and can be a transparent substrate made of other material.

With reference to step S520 and FIG. 6B, the step S520 includes forming a thin film transistor device layer on the base substrate.

The thin film transistor device layer is formed on the base substrate. The thin film transistor device layer can include a buffer layer, an active layer, a gate insulation layer, a gate electrode, an inter-dielectric layer, and a source and drain layer that are sequentially stacked upon one another from bottom to top. These disposed functional layers are known to a person of ordinary skill in the art and will not be described repeatedly herein. It should be noted that in order to show more clearly the technical solution of the present invention, specific structures of the thin film transistor device layer are omitted in the accompanying drawings, and a schematic view is made to illustrate position relations between the thin film transistor device layer and other functional layers.

With reference to step S530 and FIG. 6C, the step S530 includes forming a planarization layer on the thin film transistor device layer.

Because the structure of the array substrate film layer is complicated, which includes a non-metallic film layer, a metal film layer, line-shaped patterns, and hole-shaped patterns, the manufactured thin film transistor device layer has an uneven surface, which is disadvantageous in the later manufacture of an alignment film layer. A general method in the art is that after the manufacture of the thin film transistor layer, a planarization (PN) layer with a greater thickness is coated onto the thin film transistor layer for surface planarization. In the present embodiment, the planarization layer is an organic planarization layer, and is made of a photosensitive material.

With reference to step S540 and FIG. 6D, the step S540 includes by an exposure and develop process with a halftone mask plate, forming first regions that are recess-shaped on the planarization layer, wherein the first regions correspond to photo spacers 320 configured to support the array substrate and a color filter substrate 310.

Specifically, by employing the halftone mask plate and the exposure and development process, manufacturing shallow recesses in the planarization layer corresponding to the positions (i.e., the first regions) of the photo spacer regions can be achieved. Specifically, the planarization layer is coated, and then by the halftone mask plate, the positions (i.e., the positions corresponding to the photo spacers 320) in which shallow recesses are to be defined are exposed. Photochemical reaction changes characteristics of the organic material (i.e., exposure), and then by a photographic developer, to strip parts of the film layer on the exposed positions of the planarization layer, and parts of the film layer on the non-exposed positions are preserved. Therefore, the first regions are formed on the positions of the planarization layer corresponding to the photo spacers 320, and second regions (not shown in the figures) are formed on the positions of the planarization layer other than the first regions. In the present embodiment, a depth of the recesses of the first regions of the planarization layer corresponding to the photo spacers 320 is one fifth of a thickness of the planarization layer.

A Step S541 is further set between the step S540 and step S550 as follows.

With reference to the step S541 and FIG. 6E, the step S541 includes after the manufacture of the planarization layer with the first regions, sequentially disposing from bottom to top a common electrode layer, a passivation layer, and a pixel electrode layer on the planarization layer comprising the first regions by a deposition process.

Positions of the common electrode layer, the passivation layer, and the pixel electrode layer corresponding to the photo spacers are all correspondingly recess-shaped (the layers are formed along the recesses).

With reference to step S542 and FIG. 6F, the step S542 includes by an exposure and develop process, forming patterns on the pixel electrode layer to remove parts of the pixel electrode layer corresponding to the photo spacers. Thus, no pixel electrode layer exists in the recesses.

With reference to step S550 and FIG. 6G, the step S550 includes dropping an alignment liquid on an alignment plate, and transferring the alignment liquid from the alignment plate to the array substrate to form the alignment film layer on the planarization layer comprising the first regions, wherein the alignment film layer comprises the photo spacer regions that are recess-shaped and correspond to the photo spacers.

By a nozzle, (the alignment liquid can be but is not limited to PI alignment liquid) is dropped onto the alignment plate, and then the alignment plate is transferred to the array substrate to form PI drops at same intervals and with same volumes. Thus, in the step S550, the patterned pixel electrode layer located on the planarization layer with the first regions is coated to form a PI alignment film layer. A number of the drops (alignment liquid) dropped by the nozzle can be adjusted by machine setting parameters. The intervals of the drops of the alignment liquid is determined by the design of the alignment plate (for example, sizes of the apertures of the alignment plate). The alignment liquids, after transferred to the array substrate 200, naturally spread such that adjacent PI alignment liquids are connected into one piece to form a thin film with an even thickness. Such a method of naturally spreading and forming a film can assure that the thickness of the photo spacer regions of the alignment film layer is the same as the thickness of the non-photo spacer regions of the alignment film layer except for the photo spacer regions.

With reference to FIG. 6H, through implementation of the above steps, the alignment film layer has the recess-shaped photo spacer regions corresponding to the photo spacers. The photo spacer regions can limit the sliding ranges of the photo spacers for supporting the array substrate and the color filter substrate in the photo spacer regions respectively. When the TFT-LCD panel is exerted with an impact of an external force due to falling, because the photo spacer regions can limit the sliding ranges, the sliding ranges of the photo spacers 320 (for examples, main photo spacers, MPSs) are limited, damage of the alignment film layer is restricted in the photo spacer regions (i.e., the ranges of the recesses). Therefore, the damage to the alignment film layer due to the photo spacers 320 (especially the main photo spacers) exerted with the force and scraps generated by the alignment film layer are effectively decreased to prevent defective display issues, such as light spots, to increase anti-fall reliability of the display panel, and further to improve the quality of the products.

The above is only a preferred embodiment of the present invention, it should be noted that a person of ordinary skill in the art can also make several improvements and modifications without departing from the principle of the present invention, and these improvements and modifications should also be considered the scope of protection of the present invention.

### INDUSTRIAL APPLICABILITY

The subject matter of the present invention can be manufactured and used industrially and therefore has industrial applicability.

1. An array substrate, comprising a base substrate, wherein the array substrate further comprises:
a thin film transistor device layer, the thin film transistor device layer disposed on the base substrate;
a planarization layer, the planarization layer disposed on the thin film transistor device layer;
an alignment film layer, the alignment film layer located above the planarization layer;
a plurality of photo spacer regions defined in the alignment film layer, and positioned corresponding to photo spacers for supporting the array substrate and a color filter substrate, wherein the photo spacer regions are recess-shaped, and the photo spacer regions are configured to limit sliding ranges of the photo spacers;
a plurality of first regions defined in the planarization layer and corresponding to the photo spacer regions, and the first regions are recess-shaped.

2. The array substrate as claimed in claim 1, wherein a depth of each of the photo spacer regions of the alignment film layer is equal to a thickness of non-photo spacer regions other than the photo spacer regions of the alignment film layer.

3. The array substrate as claimed in claim 1, wherein a depth of a recess of each of the first regions of the planarization layer is one fifth of a thickness of the planarization layer.

4. The array substrate as claimed in claim 1, wherein the thin film transistor device layer comprises a buffer layer, an active layer, a gate insulation layer, a gate electrode, an inter-dielectric layer, and a source and drain layer that are sequentially stacked upon one another from bottom to top.

5. The array substrate as claimed in claim 1, wherein a common electrode layer, a passivation layer, and a pixel electrode layer that are sequentially stacked upon one another are disposed between the planarization layer and the alignment film layer.

6. A display panel, comprising the array substrate as claimed in claim 1, a color filter substrate disposed opposite to the array substrate, and a plurality of photo spacers disposed between the array substrate and the color filter substrate, wherein the photo spacers are configured to support the array substrate and the color filter substrate.

7. The display panel as claimed in claim 6, wherein the photo spacers are main photo spacers, and a transverse cross-section of each of the main photo spacers perpendicular to the array substrate is invertedly trapezoid-shaped.

8. The display panel as claimed in claim 6, wherein a first width of an end of each of the photo spacers near the array substrate is less than a second width of the photo spacer regions, and W2=W1+N, wherein W2 is the second width, W1 is the first width, N is a gap range between the second width and the first width, a value of the gap range of N is 10 μm-15 μm.

9. A manufacturing method for the array substrate as claimed in claim 1, wherein the manufacturing method comprises steps as follows:
(a) providing a base substrate;
(b) forming a thin film transistor device layer on the base substrate;
(c) forming a planarization layer on the thin film transistor device layer;
(d) by an exposure and develop process with a halftone mask plate, forming first regions that are recess-shaped on the planarization layer, wherein the first regions correspond to photo spacers configured to support the array substrate and a color filter substrate; and
(e) dropping an alignment liquid on an alignment plate, and transferring the alignment liquid from the alignment plate to the array substrate to form an alignment film layer on the planarization layer comprising the first regions, wherein the alignment film layer comprises photo spacer regions that are recess-shaped and correspond to the photo spacers.

10. The manufacturing method as claimed in claim 9, wherein a number of drops of the alignment liquid is controlled by setting parameters of a machine, and an interval between adjacent drops of the alignment liquid is determined by the alignment plate.

11. The manufacturing method as claimed in claim 9, wherein steps between the step (d) and the step (e) are as follows:
sequentially forming a common electrode layer, a passivation layer, and a pixel electrode layer on the planarization layer comprising the first regions; and
by an exposure and develop process, forming patterns on the pixel electrode layer to remove parts of the pixel electrode layer corresponding to the photo spacers.
